(19) United States
(12) Patent Application Publication
(10) Pub. No.: US 2026/0163732 A1
(43) Pub. Date: Jun. 11, 2026

(54) METHOD AND APPARATUS FOR IMPLEMENTING FINITE FIELD MULTIPLICATION

(71) Applicant: Electronics and Telecommunications Research Institute, Daejeon (KR)

(72) Inventors: Joung II YUN, Daejeon (KR); Byoung Koo KIm, Daejeon (KR); Seung Yong Yoon, Daejeon (KR); You Sung Kang, Daejeon (KR)

(73) Assignee: Electronics and Telecommunications Research Institute, Daejeon (KR)

(21) Appl. No.: 19/180,347

(22) Filed: Apr. 16, 2025

(30) Foreign Application Priority Data
Aug. 19, 2024 (KR) 10-2024-0110771

(51) Int. Cl. H04L 9/30; H04L 9/06

(52) U.S. Cl. CPC H04L 9/3026; H04L 9/0637; H04L 9/0643; H04L 9/3093

(57) ABSTRACT

A method and apparatus for finite field multiplication to operate a GHASH function in a GCM of a block cipher. An aspect of the present disclosure provides a method for performing finite field multiplication of a first and a second bit string, wherein the first bit string represents coefficients of a first polynomial in a finite field GF(2ⁿ), and the second bit string represents coefficients of a second polynomial in the finite field, comprising: generating an LUT including products of the first bit string and each of bit strings of a predetermined size in the finite field; calculating, using the LUT, a third bit string, wherein the third bit string represents coefficients of a third polynomial, wherein the third polynomial is a product of the first polynomial and the second polynomial; and performing a modulo operation on the third bit string.

### CROSS-REFERENCE TO RELATED APPLICATION

This application claims priority to Korean Patent Application No. 10-2024-0110771, filed on Aug. 19, 2024 in the Korea Intellectual Property Office, the entire contents of which are incorporated herein by reference.

### TECHNICAL FIELD

The present disclosure relates to a method and an apparatus for implementing finite field multiplication. More particularly, the present invention relates to a finite field multiplication method and apparatus for efficiently performing a GHASH function operation in a GCM operation mode of a block cipher.

### BACKGROUND

The statements in this section merely provide background information related to the present disclosure and do not necessarily constitute prior art.

A block cipher is an encryption system that encrypts plain text by dividing it into blocks of a predetermined length. A method of encrypting respective blocks in the block cipher is referred to as a block cipher mode of operation or simply a mode of operation. Operation modes include CounTeR (CTR), Electric CodeBook (ECB), Cipher Block Chaining (CBC), Cipher FeedBack (CFB), and Output FeedBack (OFB).

The Galois/Counter Mode (GCM) operation mode, which is one of the operation modes, may ensure the confidentiality and integrity of data at the same time, and plays an essential role in network security and data protection.

The GCM operation mode performs encryption by using the CTR operation mode, and generates an authentication value through a GHASH function operation. The GHASH function consists of an XOR operation on two bit strings and a finite field multiplication operation on GF(2¹²⁸). The finite field (Galois Field) multiplication is one of the important operations in cryptography and communications. In order to maximize the encryption/decryption performance in the GCM operation mode, it is necessary to efficiently implement finite field multiplication, which is a core operation of the GHASH function. In particular, there is a need for an implementation algorithm that may efficiently perform GHASH finite field multiplication in a limited computing environment such as drones and Internet of Things (IoT) devices.

On the other hand, representative methods for efficiently performing a finite field multiplication operation of two numbers include the Karatsuba algorithm and the Tom-Cook algorithm. The two algorithms are basically algorithms utilizing a split-repetition technique. The core idea of the Karachuba algorithm is to divide two n digits into two n/2 digits each, and perform three multiplications to obtain the multiplication of the original two digits. In this process, additional operations such as addition and shift are required, but the same result may be derived with a smaller number of multiplication operations, which improves speed. The Tomb-Cook algorithm may be viewed as a generalized form of the Karachuba algorithm.

These algorithms provide the possibility to efficiently implement the finite field multiplication operation and optimize the performance of the system. However, when these algorithms are actually implemented, additional operations such as a shift operation and an operation of reading and storing data in a memory are required in a process of dividing a large number into a small number and processing a multiplication operation. Thus, from a mathematical point of view for such algorithms, the computational reduction and the performance efficiency of the actual implementation may differ. In order to obtain optimal performance, it is necessary to consider a method of efficiently processing additional operations generated in the process of dividing a large number into a small number and processing a multiplication operation.

### SUMMARY

A main object of the present disclosure is to provide a method and an apparatus capable of performing finite field multiplication in a constant time.

A main object of the present disclosure is to provide a method and an apparatus capable of performing finite field multiplication at high speed in a limited computing environment such as a drone and an Internet of Things (IoT) device.

A main object of the present disclosure is to provide a method and an apparatus capable of performing finite field multiplication at high speed in a computing environment in which parallelism is not supported and separate instructions for binary finite field multiplication speeding are not provided.

Technical objects to be achieved by the present disclosure are not limited to those described above, and other technical objects not mentioned above may also be clearly understood from the detailed descriptions given below by those skilled in the art to which the present disclosure belongs.

An embodiment of the present disclosure provides a method for performing finite field multiplication of a first bit string and a second bit string, wherein the first bit string represents coefficients of a first polynomial in a finite field GF(2n) (where n is a natural number), and the second bit string represents coefficients of a second polynomial in the finite field, comprising: generating an LUT (Look-Up Table) including products of the first bit string and each of bit strings of a predetermined size in the finite field; calculating, using the LUT, a third bit string, wherein the third bit string represents coefficients of a third polynomial, wherein the third polynomial is a product of the first polynomial and the second polynomial; and performing a modulo operation on the third bit string, wherein a dividend is the third bit string and a divisor is the irreducible polynomial of the finite field.

Another embodiment of the present disclosure provides an apparatus for performing finite field multiplication of a first bit string and a second bit string, wherein the first bit string represents coefficients of a first polynomial in a finite field GF(2ⁿ) (where n is a natural number), and the second bit string represents coefficients of a second polynomial in the finite field, comprising: at least one memory storing instructions; and at least one processor, wherein the at least one processor executes the instructions to: generate an LUT including products of the first bit string and each of bit strings of a predetermined size in the finite field, calculate, using the LUT, a third bit string, wherein the third bit string represents coefficients of a third polynomial, wherein the third polynomial is a product of the first polynomial and the second polynomial, and perform a modulo operation on the third bit string, wherein a dividend is the third bit string and a divisor is the irreducible polynomial of the finite field.

According to an embodiment of the present disclosure, by reducing unnecessary operations in a finite field multiplication process, it is possible to reduce the operation complexity of finite field multiplication and improve the operation speed.

According to an embodiment of the present disclosure, there is an effect of improving the stability of the entire system by performing finite field multiplication in a constant time.

According to an embodiment of the present disclosure, by efficiently implementing finite field multiplication using basic operations such as XOR and SHIFT in a computing environment in which parallel processing and finite field fast multiplication functions are not supported, there is an effect that a GCM operation mode may be applied to various environments.

According to an embodiment of the present disclosure, there is an effect that a GCM operation mode may be applied to security such as communication and storage data protection in a drone, an Internet of Things (IoT) device, or the like based on a low-power computing platform such as a micro controller unit (MCU) or a micro processor unit (MPU).

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIGS. 1A and 1B are schematic diagrams illustrating an encryption process and a decryption process in a GCM operation mode.

FIG. 2 is a block diagram of a finite field multiplication device according to an embodiment of the present disclosure.

FIG. 3 is a pseudocode illustrating a conventional finite field multiplication implementation algorithm using the irreducible polynomial of equation 3.

FIG. 4 is a flowchart illustrating an LUT generation process according to an embodiment of the present disclosure.

FIG. 5 is a schematic diagram illustrating a process of performing the ((((U[3]>>8)+U[2])>>8+U[1])>>8+U[0]) part of Equation 9 on a 32-bit computing platform in big endian mode.

FIG. 6A is a diagram illustrating a mode of performing 1-byte right SHIFT in a Little Endian mode according to the present disclosure.

FIG. 6B is a diagram illustrating a mode of performing a 1-byte Rotation operation in a Little Endian mode according to the present disclosure.

FIG. 7 is an example code of implementing a right SHIFT operation on a 64-bit bit string in a C language code in a Little Endian mode.

FIG. 8 is a flowchart illustrating a process in which encryption and/or decryption is performed in a GCM operation mode by using the method according to the present disclosure.

FIG. 9 is a block diagram schematically illustrating an example computing device that may be used to implement a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

Definitions of terms and notations used in the present disclosure are as follows. 0^{k} means a bit string in which k bits 0 are concatenated, and 1^{k} means a bit string in which k bit 1 is concatenated. A∥B means the concatenation of bit string (or bit) A and bit string (or bit) B. A⊕B is an XOR operation of two bit strings A and B of the same length, and A⊙B is a finite field multiplication operation on GF(2ⁿ) whose irreducible polynomial is 1+x+x²+x⁷+x¹²⁸. |A|_{L} represents the bit length of a given bit string A in L-bit binary, and [A]_{L} represents the given bit string A as an L-bit bit string (zero padding if necessary). A_{i:j} is a partial bit string of the bit string A, and means a bit string from an i-th bit to a j-th bit of the bit string. A>>n is an n-bit right SHIFT operation on bit string A (e.g., 0101>>3=0³∥0).

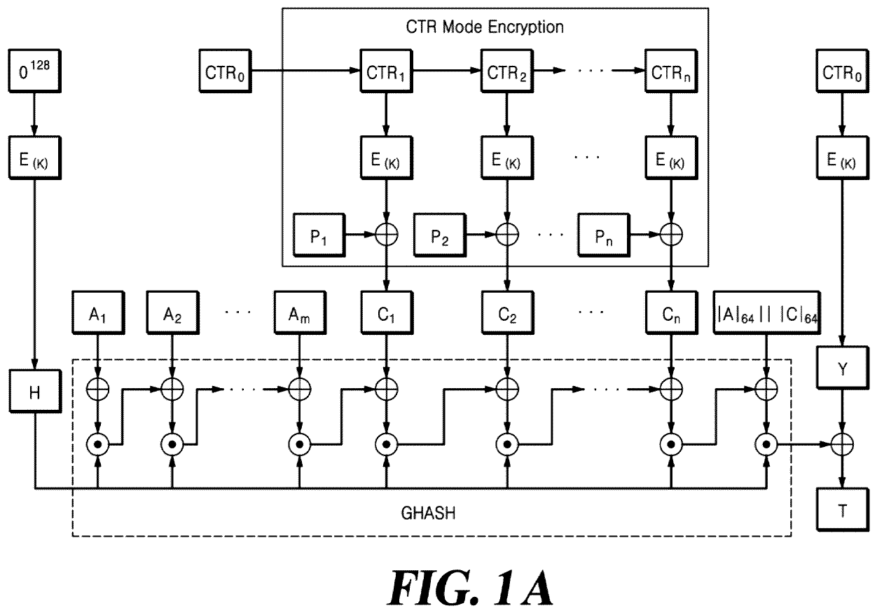

FIGS. 1A and 1B are schematic diagrams illustrating an encryption process and a decryption process in a GCM operation mode. The GCM operation mode performs encryption by using a CTR operation mode, and then generates an authentication value through a GHASH function operation. The GCM operation mode verifies the integrity of data using a hash function called GHASH.

Referring to FIG. 1A and FIG. 1B, in an encryption process using a CTR operation mode, CTR₀ is a counter initial value in the CTR operation mode. Counter values CTR₁ to CTRₙ are generated by performing a +1 mod 2³² operation (incr operation) on lower 32 bits starting with CTR₀. Here, n is the number of plaintext blocks. E_{(K)} is an encryption function of the block encryption using the symmetric key K. Pᵢ is the i-th plaintext block, and Cᵢ is the i-th encrypted block that encrypted Pᵢ using the encryption function E_{(K)}.

Referring to FIG. 1A and FIG. 1B, in a process of generating an authentication value through a GHASH function operation, H is a GHASH key value that is a value obtained by encrypting 0¹²⁸ by using the encryption function E_{(K)}, Aᵢ is an i-th additional authenticated data block, and |A|₆₄∥|C|₆₄ is a value in which bit lengths of the additional authenticated data and the encrypted data are respectively expressed as 64 bits and concatenated. Y is a value obtained by encrypting the counter initial value CTR₀ using the encryption function E_{(K)}, and T is an authentication value output as a result of the GHASH function operation, and is also referred to as an authentication tag because it is transmitted or stored by being attached to plaintext or ciphertext.

Equation 1 is an equation that defines a GHASH function operation.

$${GHASH}_{H} ( M ) = ( … ( ( ( ( ( {M}_{1} ⊙ H ) ⊕ {M}_{2} ) ⊙ H ) ⊕ {M}_{3} ) ⊙ H ) … ⊕ {M}_{n} ) ⊙ H \qquad [ Equation l ]$$

The GHASH function is an XOR (⊕) operation for two bit strings and 128-bit finite field multiplication operation (⊙) on GF (2¹²⁸). In Equation 1, Mᵢ is an i-th block obtained by dividing an input bit string M into 128-bits, and H is a 128-bit GHASH key value.

By summarizing Equation 1 using the property of finite field multiplication, Equation 2 may be derived. Referring to Equation 2, it may be seen that parallelism for the input bitstream blocks is possible in the GHASH function operation.

$${GHASH}_{H} ( M ) = ( {M}_{1} ⊙ {H}^{n} ) ⊕ ( {M}_{2} ⊙ {H}^{n - 1} ) ⊕ ( {M}_{3} ⊙ {H}^{n - 2} ) … ⊕ ( {M}_{n} ⊙ H ) \qquad [ Equation 2 ]$$

The finite field multiplication (⊙) process of Galois Field GF (2ⁿ) is as follows. Each of the n-bit bit strings is represented by an (n−1)-th order polynomial. The coefficient of each term is defined by the bit value of that order. A general polynomial multiplication is performed on a polynomial representing each bit string. When the order of a polynomial obtained by multiplying two polynomials is greater than (n−1), a modulo operation is performed to divide the polynomial by a particular “irreducible polynomial” whose order is n. The irreducible polynomial means a polynomial that may no longer be factorized. The irreducible polynomial is used when defining a finite field, and the reason for performing a modulo operation on the product of two polynomials in the finite field is to ensure that the result of the operation always belongs to the finite field.

In summary, the finite field multiplication process of Galoisfield GF (2ⁿ) may be divided into two steps. The first step is a polynomial multiplication process in which two bit strings to be multiplied are converted into a polynomial form and polynomial multiplying is performed. The second step is a modulo operation process of, when the order of the polynomial obtained in the first step is equal to or greater than the order of the irreducible polynomial for finite field multiplication, calculating the remaining polynomial by dividing the polynomial obtained in the first step by the irreducible polynomial, and converting the remaining polynomial into a bit string.

In the process of implementing finite field multiplication on GF (2ⁿ) by software or hardware, operation expressions such as multiplication and addition of polynomials are interpreted only semantically, multiplication of each term is implemented by SHIFT operation, and addition is implemented by a bitwise XOR operator. Multiplication operations and modulo operations of polynomial may be implemented in various forms according to a polynomial theorem using properties of finite bodies such as associativity, commutativity, and distributivity. There is also a large difference in implementation efficiency depending on whether the processing unit of the operation is a bit unit or a block unit (byte, word, or the like).

Since the finite field multiplication is the core of the GHASH function operation, efficient implementation of the finite field multiplication operation is required. As a conventional implementation algorithm for finite field multiplication on GF (2ⁿ), an XTime algorithm that processes in bit units and a Block-Comb algorithm that processes in block units are used. Since the performance of modulo operation varies greatly depending on the implementation method, various optimization methods for modulo operation such as a modulus reduction algorithm are also used.

A conventional GHASH implementation method for speeding up a GCM operation mode may obtain performance improvement by processing finite field multiplication on each of a plurality of blocks constituting long plaintext message data in parallel. However, drones and Internet of Things (IoT) devices based on low-power computing platforms such as Micro Controller Units (MCUs) and Micro Processor Units (MPUs) are widely used, and parallel processing is not supported in such a computing environment, and separate instructions for speeding up binary finite field multiplication are not provided. The present disclosure discloses a finite field multiplication method and apparatus that may perform finite field multiplication at high speed even in a limited computing environment.

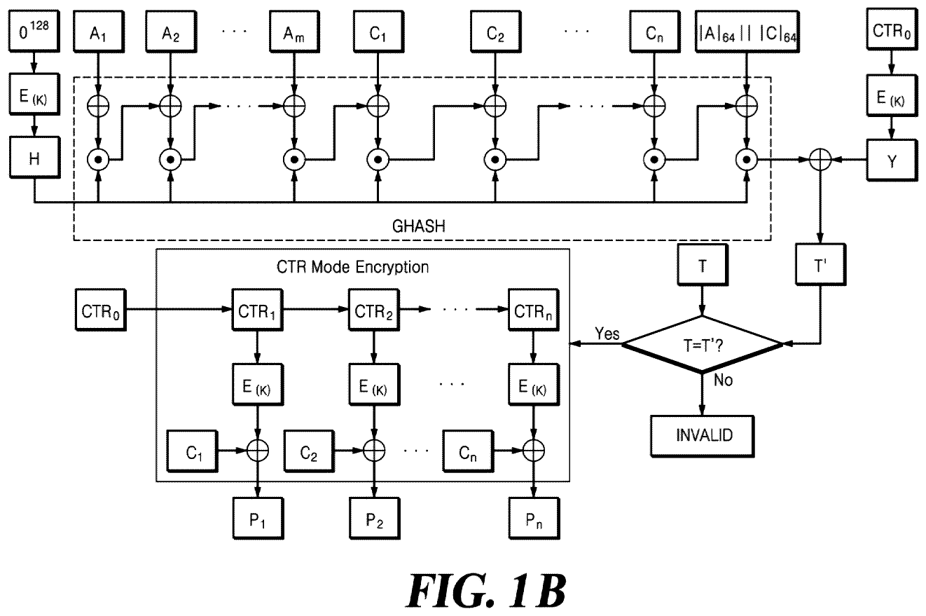

FIG. 2 is a block diagram of a finite field multiplication device according to an embodiment of the present disclosure.

A finite field multiplication device 100 includes a memory 110 and a processor 120. The finite field multiplication device 100 may be implemented in a form of an embedded device, a server, an electronic device in an autonomous driving system, or the like. Not all blocks shown in FIG. 2 are essential components, and in other embodiments, some blocks included in the finite field multiplication apparatus 100 may be added, changed, or deleted. On the other hand, the components shown in FIG. 2 represent functionally distinct elements, and may be implemented in a form in which at least one component is integrated with each other in an actual physical environment.

The memory 110 stores data and commands necessary for the operation of the finite field multiplication device 100. The processor 120 controls the overall operation of the finite field multiplication device 100. The processor 120 may be implemented as one or more processors. The processor 120 may execute instructions stored in the memory 110.

Equation 3 is an example of an irreducible polynomial for modulo operation of finite field multiplication on GF 2¹²⁸, and represents an irreducible polynomial used for GHASH function operation.

$$g ( x ) = 1 + x + {x}^{2} + {x}^{7} + {x}^{128} \qquad [ Equation 3 ]$$

In Equation 3, the constant term corresponds to the most significant bit (MSB) of the 128-bit bit string, and the coefficient of the x¹²⁷ term corresponds to the least significant bit (LSB) of the 28-bit bit string. Such a finite field multiplication notation mode is a finite field multiplication notation mode of a GHASH function defined by the National Institute of Standards and Technology (NIST SP 800-38D, Recommendation for Block Cipher Modes of Operation: Galois/Counter Mode (GCM) and GMAC, 2007). Since the order of the irreducible polynomial g(x) is 128, the result of finite field multiplication is a 128-bit bit string.

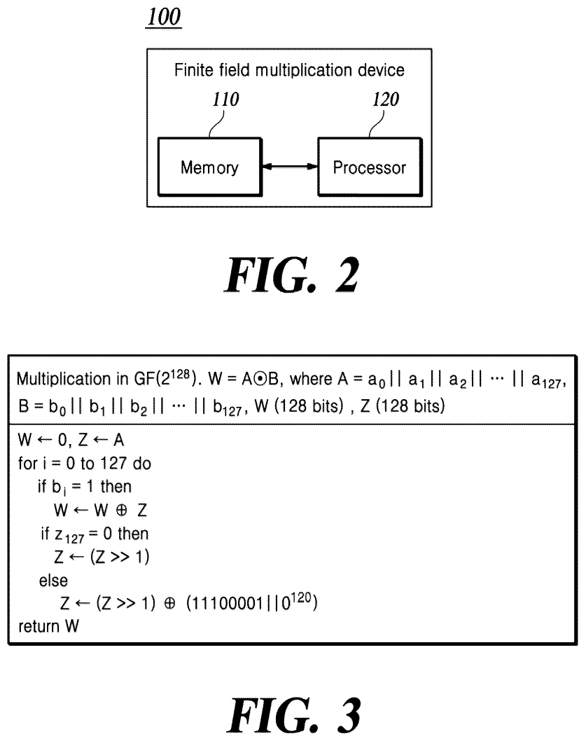

FIG. 3 is a pseudocode illustrating a conventional finite field multiplication implementation algorithm using the irreducible polynomial of equation 3. A conventional basic finite field multiplication algorithm processes a finite field multiplication process in a bit unit. In a conventional finite field multiplication algorithm, when a result of bit-wise multiplication is greater than 128 bits (i.e., when the 128th bit (z₁₂₇) of Z before SHIFT is 1) by using a right SHIFT operation, an XOR operation is performed on a 128-bit bit string 11100001∥0¹²⁰ corresponding to an irreducible polynomial of Equation 3 and a 1-bit SHIFT Z, and a modulo operation is performed.

Since a conventional finite field multiplication algorithm is repeatedly performed by a length of an input bit string, a processing speed is low, and since a conditional statement for checking a bit value is included, an execution time of finite field multiplication may vary according to the input bit string, which may be vulnerable to a side-channel attack or the like. In order to solve such a problem, an algorithm for processing on a block-by-block basis rather than a bit-by-bit basis, an algorithm for replacing an operation that is repeatedly performed with a look-up table (LUT), or the like may be used. However, in order to prepare for a side-channel attack or the like, it is necessary to be able to perform finite field multiplication in a constant time. A method for implementing finite field multiplication of a GHASH function according to the present disclosure may perform finite field multiplication in a constant time.

A method for implementing finite field multiplication of a GHASH function according to an embodiment of the present disclosure may be divided into a first step of generating an LUT and a second step of performing finite field multiplication. The first step (i.e., the LUT generation step) is a process of generating the LUT based on a GHASH key H in order to speed up the finite field multiplication of the GHASH function. The second step (i.e., the finite field multiplication step) is a process of performing an encryption process or a decryption process by using the LUT.

The first step (LUT generation step) is a step of pre-calculating an LUT in order to replace a pre-processable operation portion in the entire finite field multiplication process with an Look-Up Table (LUT). By using a pre-calculated LUT, optimal performance may be obtained in the trade-off of speed up and memory usage increase.

In the LUT generation step, an LUT in which products of the GHASH key H and an input value (0 to 255) having a byte size (8 bits) are stored is generated. Since the LUT generation step is an initial setting process for the finite field multiplication operation of the present disclosure, it is initially executed only once unless otherwise specified.

Generally, given an encryption key, encryption or decryption is performed in a state in which the value of the encryption key is fixed. Since the value of the encryption key is fixed, the value of the GHASH key H also does not change during the encryption process or the decryption process. Therefore, by storing the result of the operation repeatedly performed in the finite field multiplication process in the LUT, the operation efficiency of the finite field multiplication may be improved. To minimize the increase in memory usage due to the use of LUT while also minimizing the decrease in performance due to memory reads/writes, a finite field multiplication result for bit string values (0 to 255) of a byte size (8 bits), which is the smallest unit of most memory read/write operations, is generated.

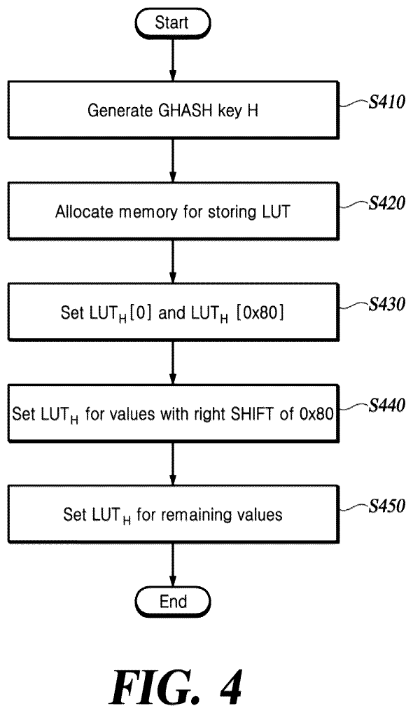

FIG. 4 is a flowchart illustrating an LUT generation process according to an embodiment of the present disclosure.

The finite field multiplication device 100 generates a GHASH key H by inputting 0¹²⁸ to the block cipher encryption function E_{(K)} set to the encryption key K (S410).

A memory having a size of 128×256 bits is allocated to store products of 128-bit H in the finite field (S420). LUT_{H}[y] represents the products of H⊙y. Here, y is an 8-bit bit string and is an integer value of 0 or more and 255 or less, and when y is expressed as a hexadecimal number, y is a value of 0x00 or more and 0xFF or less.

Since H⊙00000000=0¹²⁸, LUTH[0]=0128 is set, and since H=10000000=H, LUT_{H}[0x80]=H is set (S430).

A result of finite field multiplication of values (0x40, 0x20, 0x10, 0x08, 0x04, 0x02, 0x01) obtained by SHIFT 0x80 to the right by 1 bit ((H⊙01000000, H⊙00100000, H⊙00010000, H⊙00001000, H⊙00000100, H⊙00000010, H⊙00000001) is obtained, and is set to LUT_{H}[0x40], LUT_{H}[0x20], LUT_{H}[0x10], LUT_{H}[0x08], LUT_{H}[0x04], LUT_{H}[0x02], LUT_{H}[0x01], respectively (S440). In operation S440, a conventional finite field multiplication method such as the algorithm of FIG. 3 may be used.

The LUT value for the remaining y values is calculated (S450). The LUT value for the remaining y values for which the product in the finite field has not been calculated may be calculated with an XOR combination of the already set LUT values. That is, values that have not yet been calculated in the LUT may be calculated by an XOR combination of the values LUT_{H}[0x80], LUT_{H}[0x40], LUT_{H}[0x20], LUT_{H}[0x10], LUT_{H}[0x08], LUT_{H}[0x04], LUT_{H}[0x02] and LUT_{H}[0x01] set in the process S430 and the process S440 or an XOR combination with other LUT values that have already been set. The process S450 may be performed by using a property of a finite field such as a coupling law, an exchange law, and a distribution law. For example, 0xA2 is 10100010 in binary and 10100010=10000000 (00100000 e 00000010, LUTH [0xA2] may be obtained with the XOR combination of the already calculated LUT values. Equation 4 represents a process of calculating LUT_{H}[0xA2] using other LUT values that have already been set.

$$\begin{matrix}{LUT}_{H} [ 0 \times A 2 ] = H ⊙ 10100010 \\ = H ⊙ ( 10000000 ⊕ 00100000 ⊕ 00000010 ) \\ = ( H ⊙ 10000000 ) ⊕ ( H ⊙ 00100000 ) ⊕ \\ ( H ⊙ 00000010 ) \\ = {LUT}_{H} [ 0 \times 80 ] ⊕ {LUT}_{H} [ 0 \times 20 ] ⊕ \\ {LUT}_{H} [ 0 \times 02 ]\end{matrix} \qquad [ Equation 4 ]$$

A method of reducing unnecessarily redundant operations by utilizing a previous calculation result LUT according to a multiplication order for values from 0x00 to 0xFF may also be applied. A person skilled in the art may obtain the LUT according to the present disclosure by using the efficient implementation methods proposed in the prior art.

In the second step, the finite field multiplication step, polynomial multiplication and modulo operation are performed using the LUT generated in the first step.

Since the first step is executed only once, it does not significantly affect the actual performance, but the finite field multiplication step of encrypting or decrypting the input data and outputting may determine the performance of the GHASH function operation. The finite field multiplication method according to the present disclosure may improve efficiency of finite field multiplication by using the LUT generated in the first step.

A bit string B is a 128-bit input bit string, and is a bit string to be subjected to finite field multiplication with the GHASH key H. When the bit string B is divided into 8-bit segments, the bit string B may be represented by B_{0:7}∥B_{8:15}∥B_{16:23}∥ . . . ∥B_{120:127}. Here, B_{i:j} is a partial bit string of the bit string B and is a bit string from the i-th bit to the j-th bit of the bit string B. For example, B_{0:7} is an 8-bit bit string, and b₀∥b₁∥b₂∥b₃∥b₄∥b₅∥b₆∥b₇.

Equation 5 is a finite field multiplication HOB represented using a bit string B divided into segments of 8-bit size.

$$H ⊙ B = H ⊙ ( {B}_{0 : 7} + {B}_{8 : 15} {x}^{8} + {B}_{16 : 23} {x}^{16} + … + {B}_{120 : 127} {x}^{120} ) mod g ( x ) \qquad [ Equation 5 ]$$

In Equation 5, g(x) is the irreducible polynomial of Equation 3, and mod is the modulo operation. Since the finite field multiplication operation and the modulo operation satisfy the distribution law and the exchange law, Equation 6 may be derived from Equation 5.

$$H ⊙ B = [ ( H ⊙ {B}_{0 : 7} ) mod g ( x ) + ( ( H ⊙ {B}_{8 : 15} ) mod g ( x ) ) {x}^{8} + ( ( H ⊙ {B}_{16 : 23} ) mod g ( x ) ) {x}^{16} + … + ( ( H {B}_{120 : 127} ) mod g ( x ) ) {x}^{120} ] mod g ( x ) \qquad [ Equation 6 ]$$

Equation 6 may be expressed by using the LUT generated in the first step as shown in Equation 7.

$$H ⊙ B = [ {LUT}_{H} [ {B}_{0 : 7} ] + {LUT}_{H} [ {B}_{8 : 15} ] {x}^{8} + {LUT}_{H} [ {B}_{16 : 23} ] {x}^{16} + … + {LUT}_{H} [ {B}_{120 : 127} ] {x}^{120} ] mod g ( x ) \qquad [ Equation 7 ]$$

In Equation 7, the x⁸, x¹⁶, . . . and x¹²⁰ terms are terms whose order is a multiple of 8, and are equal to the 8, 16, . , . s, 120 bits right SHIFT operation, respectively. In an actual implementation, an addition operation, that is, an XOR operation is performed at positions where the memory addresses in bytes are increased to 1, 2, . . . and 15, respectively, without a SHIFT operation.

Equation 8 is an equation that summarizes Equation 7 from the perspective of actual implementation.

$$H ⊙ B = [ {LUT}_{H} [ {B}_{0 : 7} ] + {LUT}_{H} [ {B}_{8 : 15} ] ≫ 8 ) + ( {LUT}_{H} [ {B}_{16 : 23} ] ≫ 16 ) + … + ( {LUT}_{H} [ {B}_{120 : 127} ] ≫ 120 ) ] mod g ( x ) = [ {{LUT}_{H} [ {B}_{0 : 7} ]}_{0.7} \vert \vert {{LUT}_{H} [ {B}_{0 : 7} ]}_{8 : 15} ⊕ {{LUT}_{H} [ {B}_{8 : 15} ]}_{0 : 7} ) \vert \vert {{LUT}_{H} [ {B}_{0 : 7} ]}_{16 : 23} ⊕ {{LUT}_{H} [ {B}_{8 : 15} ]}_{8 \text{:1} 5} ⊕ {{LUT}_{H} [ {B}_{16 : 23} ]}_{0 : 7} ) \vert \vert … \vert \vert ( {{LUT}_{H} [ {B}_{104 : 111} ]}_{120 : 127} ⊕ {{LUT}_{H} [ {B}_{112 : 119} ]}_{112 : 119} ⊕ {{LUT}_{H} [ {B}_{120 : 127} ]}_{104 : 111} ) \vert \vert ( {{LUT}_{H} [ {B}_{112 : 119} ]}_{120 : 127} ⊕ {{LUT}_{H} [ {B}_{120 : 127} ]}_{112 : 119} ) \vert \vert {{LUT}_{H} [ {B}_{120 : 127} ]}_{120 : 127} ] mod g ( x ) \qquad [ Equation 8 ]$$

When Equation 7 is implemented in the form of Equation 8, memory read/write and operation are performed in bytes. In the finite field multiplication method according to the present disclosure, Equation 7 is summarized as Equation 9 below to enable more efficient operation on a computing platform in which the unit of memory access and operation is 32 bits (or 16 bits). Equation 9 is an equation for performing a finite field multiplication operation on a 32-bit computing platform. A person of ordinary skill in the art may also derive an equation such as Equation 9 for a 16-bit computing platform.

$$H ⊙ B = [ ( ( ( {LUT}_{H} [ {B}_{24 : 31} ] + {LUT}_{H} [ {B}_{56 : 63} ] {x}^{32} + {LUT}_{H} [ {B}_{88 : 95} ] {x}^{64} + {LUT}_{H} [ {B}_{120 : 127} ] {x}^{96} ) {x}^{8} + LU {T}_{H} [ {B}_{16 : 23} ] + {LUT}_{H} [ {B}_{48 : 55} ] {x}^{32} + {UT}_{H} [ {B}_{80 : 87} ] {x}^{64} + {LUT}_{H} [ {B}_{112 : 119} ] {x}^{96} ) {x}^{8} + {LUT}_{H} [ {B}_{8 : 15} ] + {LUT}_{H} [ {B}_{40 : 47} ] {x}^{32} + {LUT}_{H} [ {B}_{72 : 79} ] {x}^{64} + {LUT}_{H} [ {B}_{104 : 111} ] {x}^{96} ) {x}^{8} + {LUT}_{H} [ {B}_{0 : 7} ] + {LUT}_{H} [ {B}_{32 : 39} ] {x}^{32} + {LUT}_{H} [ {B}_{64 : 71} ] {x}^{64} + {LUT}_{H} [ {B}_{96 : 103} ] {x}^{96} ] mod g ( x ) = [ ( ( ( U [ 3 ] {x}^{8} ) + U [ 2 ] ) {x}^{8} + U [ 1 ] ) {x}^{8} + U [ 0 ] ] mod g ( x ) = [ ( ( ( U [ 3 ] ≫ 8 ) + U [ 2 ] ) ≫ 8 + U [ 1 ] ) ≫ 8 + U [ 0 ] ] mod g ( x ) \qquad [ Equation 9 ]$$

In Equation 9,

$$U [ i ] = {\sum }_{k = 0}^{3} {LUT}_{H} [ {B}_{( 8 i + 32 k ) : ( 8 i + 32 k + 7 )} ] {x}^{32 k} .$$

Since the order of the terms x³², x⁶⁴, and x⁹⁶ in Equation 9 is a multiple of 32, the memory may be accessed in units of words (32-bit). Thus, it is effective for memory structures that process memory read/write processes on 32-bit units. In addition, by performing the XOR operation in units of 32-bits, the XOR operation processing speed may also be improved.

In Equation 9, since x⁸ is a process of performing 1-byte (i.e., 8-bit) right SHIFT on the entire bit string, memory read/write efficiency is reduced in a 32-bit computing platform. The finite field multiplication method according to the present disclosure may minimize the number of 1-byte right SHIFT operations by performing an XOR operation and a SHIFT operation in the order of operations in Equation 9.

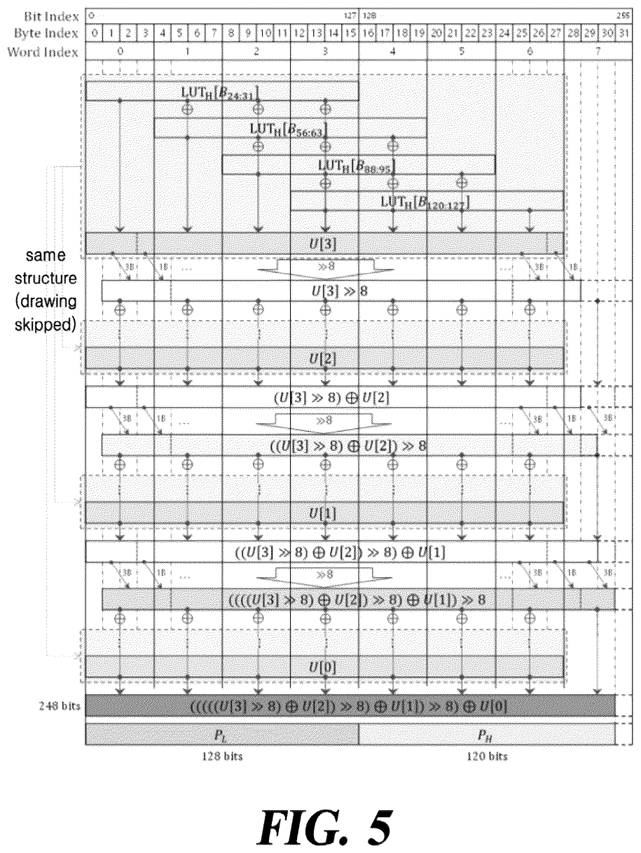

FIG. 5 is a schematic diagram illustrating a process of performing the [(((U[3]>>8)+U[2])>>8+U[1])>>8+U[0]] part of Equation 9 on a 32-bit computing platform in big endian mode. Referring to FIG. 5, a process in which finite field multiplication is performed according to an operation order of Equation 9 may be seen on a memory.

The XOR operation is performed in 32-bit (4-byte) units, and the 1-byte SHIFT operation is performed by dividing 32 bits into 24 bits and 8 bits and copying the memory in 32-bit units. When memory accesses and operations are performed in 32-bit (or 16-bit) units that may be processed at a time on a 32-bit (or 16-bit) computing platform, the memory accesses and XOR operations are reduced during finite field multiplication operations, thereby increasing the efficiency of finite field multiplication.

In an actual implementation process in a computing platform, not only an operation efficiency problem related to a processing unit of a memory but also a problem due to endian conversion needs to be considered. In the big endian mode, the most significant byte of data is stored at a low address, while in the little endian mode, the least significant byte of the data is stored at the low address. Therefore, in the Little Endian mode, when data is processed in units of words (32 bits), the order of bytes stored in the memory is changed. Conventionally, an inefficient manner of performing memory copy in units of 1 byte has been used to perform a 1-byte (8-bit) right SHIFT in the Little Endian mode.

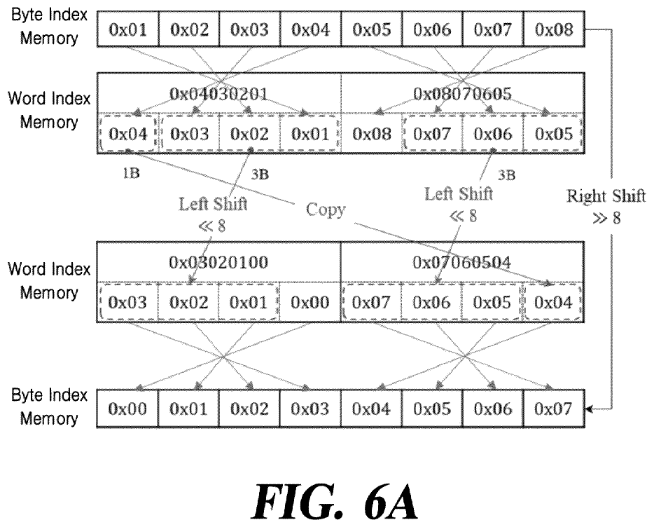

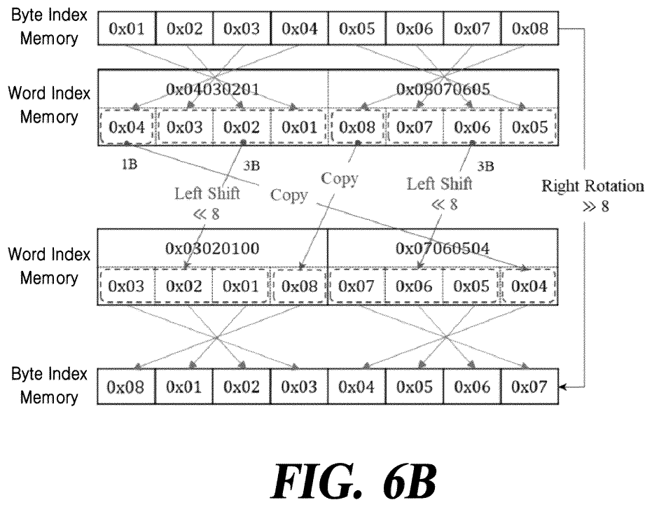

FIG. 6A is a diagram illustrating a mode of performing 1-byte right SHIFT in a Little Endian mode according to the present disclosure. Referring to FIG. 6A, by performing a left SHIFT operation and memory copying by using a feature of a byte arrangement order structure including 32-bit word data of a Little Endian mode, the same result as that of 1-byte right SHIFT may be obtained. Therefore, it is possible to obtain a result of 1-byte right SHIFT by operation in units of 32-bits.

FIG. 6B is a diagram illustrating a mode of performing a 1-byte Rotation operation in a Little Endian mode according to the present disclosure. Referring to FIG. 6B, a left SHIFT operation and a memory copy are performed by using a feature of a byte arrangement order structure including 32-bit word data of a Little Endian mode, so that the same result as that of 1-byte rotation may be obtained. Therefore, a 1-byte rotation operation result may be obtained by operation in units of 32-bits.

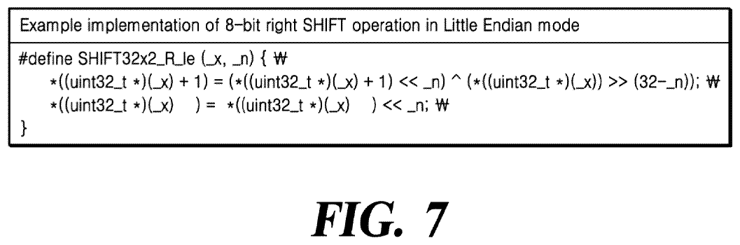

FIG. 7 is an example code of implementing a right SHIFT operation on a 64-bit bit string in a C language code in a Little Endian mode. In FIG. 7, _n is a value of one of 8, 16, and 24. Those skilled in the art will be able to extend the code of FIG. 7 to SHIFT operations on longer length bit strings using conventional engineering concepts.

In Equation 9, when a bit string obtained by performing [(((U[3]>>8)+U[2])>>8+U[1])>>8+U[0]] is denoted as P, the length of the bit string P for which a modulo operation needs to be performed is 248 bits, which is 8 bits less than 256 bits. This is because the LUT in which the products of the 8-bit bit strings and the GHASH key H in the finite field are stored is used in the present disclosure. The method according to the present disclosure utilizes the feature that the length of the bit string P is less than 256 bits to simplify the modulo operation.

Equation 9 may be expressed as Equation 10 using the bit string P.

$$H ⊙ B = [ ( ( ( U [ 3 ] {x}^{8} ) + U [ 2 ] ) {x}^{8} + U [ 1 ] ) {x}^{8} + U [ 0 ] ] mod g ( x ) = P mod g ( x ) = ( {P}_{L} \vert \vert {P}_{H} ) mod g ( x ) = ( {P}_{L} + {P}_{H} {x}^{128} ) mod g ( x ) = {P}_{L} mod g ( x ) + {P}_{H} {x}^{128} mod g ( x ) \qquad [ Equation 10 ]$$

In Equation 10, P_{L} is a 128-bit bit string, which corresponds to the leftmost 128 bits (P_{0:127}) of P, and P_{H} is a 120-bit bit string which corresponds to the rightmost 120 bits (P_{128:247}) of P.

In Equation 10, P_{L} belongs to GF 2¹²⁸ because it is a 128-bit bit string. Therefore, it is not necessary to perform a modulo operation on the P_{L}. The modulo operation for P_{H}·x¹²⁸ may be replaced with the modulo operation of P_{H}·(1+x+x²+x⁷) based on the fact that the polynomial g(x)=1+x+x²+x⁷+x¹²⁸. Equation 11 is an equation that represents Equation 10 as an alternative modulo operation.

$$H ⊙ B = {P}_{L} + {P}_{H} ( 1 + x + {x}^{2} + {x}^{7} ) mod g ( x ) = {P}_{L} + ( {P}_{H} + {P}_{H} x + {P}_{H} {x}^{2} + {P}_{H} {x}^{7} ) mod g ( x ) = {P}_{L} + [ {P}_{H} + ( {P}_{H} ≫ 1 ) + ( {P}_{H} ≫ 2 ) + ( {P}_{H} ≫ 7 ) ] mod g ( x ) = {P}_{L} + {P}_{H} + ( {P}_{H} ≫ 1 ) + ( {P}_{H} ≫ 2 ) + ( {P}_{H} ≫ 7 ) = {P}_{L} ⊕ {P}_{H} \vert \vert {0}^{8} ⊕ 0 \vert \vert {P}_{H} \vert \vert {0}^{7} ⊕ {0}^{2} \vert \vert {P}_{H} \vert \vert {0}^{6} ⊕ {0}^{7} \vert \vert {P}_{H} \vert \vert 0 \qquad [ Equation 11 ]$$

In Equation 11, P_{H} is a 120-bit bit string, so the result of the SHIFT and XOR operation with the x, x², x⁷ terms is a 127-bit bit string. Therefore, the modulo operation on P_{H}·x₁₂₈ may be implemented by three SHIFT operations and four XOR operations on the 120-bit bit string, thereby increasing the operation speed.

In addition, when the finite field multiplication operation is implemented in the form of Equation 11, since there is no branching process according to the bit value, the execution time of the finite field multiplication is a constant time. Therefore, safety against a side-channel attack may be enhanced.

A similar method of replacing the modulo operation with the SHIFT has been proposed, but the present disclosure proposes a method of simplifying the process of replacing a modulo operation by the SHIFT by configuring the length of a bit string for which the modulo calculation needs to be performed to be 248-bits and utilizing the feature that the order of terms other than the highest order term of the GHASH finite field multiplication irreducible polynomial is 7 or less.

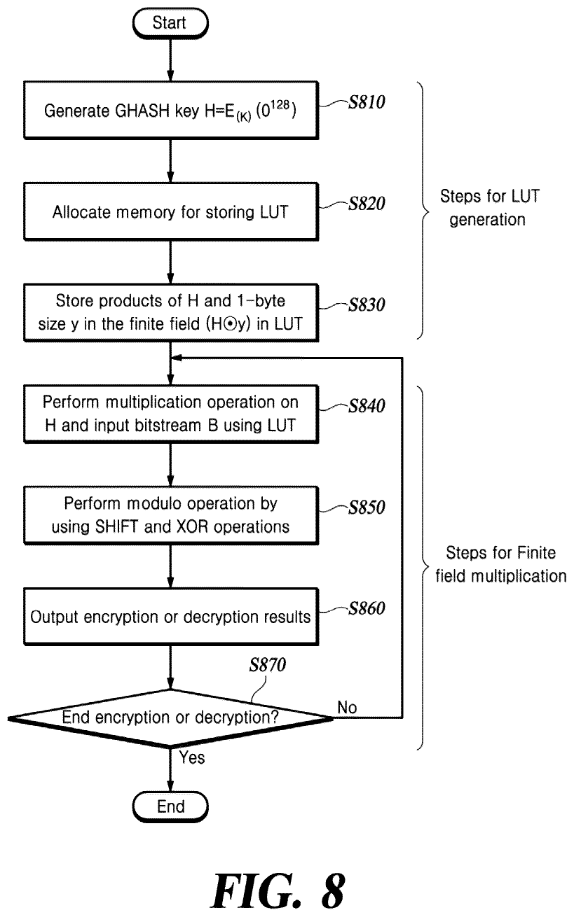

FIG. 8 is a flowchart illustrating a process in which encryption and/or decryption is performed in a GCM operation mode by using the method according to the present disclosure. In FIG. 8, steps S810 to S830 correspond to the first step (LUT generation step), and steps S840 to S850 correspond to the second step (finite field multiplication step).

The finite field multiplication device 100 generates a GHASH key H by inputting 0¹²⁸ to the block cipher encryption function E_{(K)} set to the encryption key K (S810). A memory for storing an LUT is allocated (S820). Products of H and y having a size of 1 byte in the finite field (H⊙y) are calculated and stored in the LUT (S830).

The LUT is used to perform polynomial multiplication on the H and an input bit string B (S840). Using SHIFT operation and XOR operation, a modulo operation is performed in which a polynomial obtained by multiplying the H and the input bit string B as a dividend and the irreducible polynomial as a divisor (S850). The result of encrypting or decrypting the block is output (S860).

It is checked whether encryption or decryption is performed on all blocks (S870). When encryption or decryption is performed on all the blocks (S870—YES), the process of encryption or decryption ends (S880). When there is a block that has not yet been encrypted or decrypted (S870—NO), the process moves to step S840 and the finite field multiplication step is performed.

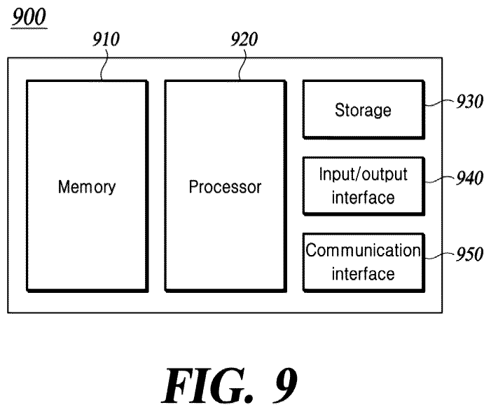

FIG. 9 is a block diagram schematically illustrating an example computing device that may be used to implement a method or an apparatus according to the present disclosure.

A computing device 900 may include some or all of a memory 910, a processor 920, a storage 930, an input/output interface 940, and a communication interface 950. The computing device 900 may structurally and/or functionally include at least a portion of a device in accordance with the present disclosure. The computing device 900 may be a stationary computing device such as a desktop computer, a server, or the like, as well as a mobile computing device, such as a laptop computer, a smart phone, a vehicle battlefield, or the like.

The memory 910 may store a program that causes the processor 920 to perform a method or an operation according to various embodiments of the present disclosure. For example, the program may include a plurality of instructions executable by the processor 920, and the method or operations described above may be performed by the plurality of instructions being executed by the processor 910. The memory 910 may be a single memory or a plurality of memories. In this case, information required for performing the methods or operations according to various embodiments of the present disclosure may be stored in a single memory or may be separately stored in a plurality of memories. When the memory 910 is configured with a plurality of memories, the plurality of memories may be physically separated. The memory 910 may include at least one of a volatile memory and a nonvolatile memory. The volatile memory includes a static random access memory (SRAM), a dynamic random access memory (DRAM), or the like, and the nonvolatile memory includes a flash memory or the like.

The processor 920 may include at least one core capable of executing at least one instruction. The processor 920 may execute instructions stored in the memory 910. The processor 920 may be a single processor or a plurality of processors.

The storage 930 maintains stored data even when power supplied to the computing device 900 is interrupted. For example, the storage 930 may include a non-volatile memory, and may include a storage medium such as a magnetic tape, an optical disc, or a magnetic disk. The program stored in the storage 930 may be loaded into the memory 910 before being executed by the processor 920. The storage 930 may store a file written in a program language, and a program generated by a compiler or the like from the file may be loaded into the memory 910. The storage 930 may store data to be processed by the processor 920 and/or data processed by the processor 820.

The input/output interface 940 may provide an interface with an input device such as a keyboard, mouse, or the like and/or an output device such as a display device, printer, or the like. A user may trigger execution of a program by the processor 920 through an input device, and/or check a processing result of the processor 920 via an output device.

The communication interface 950 may provide access to an external network. The computing device 900 may communicate with other devices via the communication interface 950.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for performing finite field multiplication of a first bit string and a second bit string, wherein the first bit string represents coefficients of a first polynomial in a finite field GF(2ⁿ) (where n is a natural number), and the second bit string represents coefficients of a second polynomial in the finite field, comprising:
generating an LUT (Look-Up Table) including products of the first bit string and each of bit strings of a predetermined size in the finite field;
calculating, using the LUT, a third bit string, wherein the third bit string represents coefficients of a third polynomial, wherein the third polynomial is a product of the first polynomial and the second polynomial; and
performing a modulo operation on the third bit string, wherein a dividend is the third bit string and a divisor is the irreducible polynomial of the finite field.

2. The method of claim 1, wherein the finite field is GF(2¹²⁸).

3. The method of claim 1, wherein the first bit string is a GHASH key in a GCM (Galois/Counter Mode).

4. The method of claim 1, wherein the predetermined size is one byte.

5. The method of claim 1, wherein the generating the LUT comprises:
calculating a products of the first bit string and each of one-hot bit strings of the predetermined size in the finite field; and
calculating, by using the products of the first bit string and each of the one-hot bit strings of the predetermined size in the finite field, the products of the first bit string and remaining bit strings of the predetermined size in the finite field.

6. The method of claim 1, wherein the third bit string is calculated based on values stored in the LUT, by using XOR operations and SHIFT operations.

7. The method of claim 1, wherein the calculating the third bit string comprises:
dividing the second bit string into a plurality of segments of the predetermined size;
obtaining, by using the LUT, a products of the first bit string and each of the plurality of segments in the finite field; and
performing XOR operations on a plurality of products among the products of the first bit string and each of the plurality of segments in the finite field, wherein memory offset between the plurality of products is multiples of a memory access unit of a processor.

8. The method of claim 7, wherein the memory access unit of the processor is 16-bit or 32-bit.

9. The method of claim 1, wherein the modulo operation on the third bit string is performed by using XOR operations and SHIFT operations.

10. The method of claim 1, wherein the performing the modulo operation on the third bit string comprises:
dividing the third bit string into a fourth bit string and a fifth bit string, wherein the fourth bit string composed of left n bits of the third bit string and the fifth bit string composed of rest of bits except the left n bits of the third bit string; and
performing a modulo operation on the fifth bit string by using XOR operations and SHIFT operations, wherein a dividend is the fifth bit string and a divisor is the irreducible polynomial of the finite field.

11. An apparatus for performing finite field multiplication of a first bit string and a second bit string, wherein the first bit string represents coefficients of a first polynomial in a finite field GF(2ⁿ) (where n is a natural number), and the second bit string represents coefficients of a second polynomial in the finite field, comprising:
at least one memory storing instructions; and
at least one processor,
wherein the at least one processor executes the instructions to:
generate an LUT including products of the first bit string and each of bit strings of a predetermined size in the finite field,
calculate, using the LUT, a third bit string, wherein the third bit string represents coefficients of a third polynomial, wherein the third polynomial is a product of the first polynomial and the second polynomial, and
perform a modulo operation on the third bit string, wherein a dividend is the third bit string and a divisor is the irreducible polynomial of the finite field.
